(19) United States
(12) Patent Application Publication
(10) Pub. No.: US 2022/0085449 A1
(43) Pub. Date: Mar. 17, 2022

(54) ELECTRICITY STORAGE DEVICE, ELECTRIC-POWERED VEHICLE, AND MEHTOD OF MANUFACTURING AN ELECTRICITY STORAGE DEVICE

(71) Applicant: DAI NIPPON PRINTING CO., LTD., Tokyo (JP)

(72) Inventor: Jun FUKUDA, Tokyo (JP)

(73) Assignee: DAI NIPPON PRINTING CO., LTD., Tokyo (JP)

(21) Appl. No.: 17/423,020

(22) PCT Filed: Nov. 14, 2019
(86) PCT No.: PCT/JP2019/044658

§ 371 Date: Jul. 14, 2021

(30) Foreign Application Priority Data
Jan. 18, 2019 (JP) 2019-006662

(51) Int. Cl. H01M 50/249; H01M 50/209; H01M 50/103; H01M 50/553

(52) U.S. Cl. CPC H01M 50/249; H01M 50/209; H01M 2220/20; H01M 50/553; H01M 50/103

(57) ABSTRACT

An electricity storage device, a plurality of planar electricity storage cells each having an electricity storage element sealed in a primary packing container are stacked on each other in tiers and sealed in a secondary packing container. The primary packing container is formed of a bag of resin formed by thermally bonding together peripheral parts of a resin sheet formed by laying on each other a barrier layer with a vapor-deposited coating and a thermal adhesive resin layer. The secondary packing container includes a first packing material and a second packing material each formed of a resin sheet formed by laying on each other a metal foil and a thermal adhesive resin layer, and peripheral parts of the first and second packing materials and are thermally bonded together.

### TECHNICAL FIELD

The present invention relates to an electricity storage device for mounting in an electric-powered vehicle and to a method of manufacturing such an electricity storage device. The present invention relates also to an electric-powered vehicle in which such an electricity storage device is mounted.

### BACKGROUND ART

Today, from the perspective of environment protection and resources saving, electric-powered vehicles, of which at least part of the driving force is supplied by a motor, have been attracting much attention. Electric-powered vehicles include electric vehicles (EVs), hybrid electric vehicles (HEVs), and plug-in hybrid electric vehicles (PHEVs). Electric vehicles use solely a motor as a driving power source; hybrid electric vehicles and plug-in hybrid electric vehicles use a motor and an engine as a driving power source.

Patent Document 1 identified below discloses a known electricity storage device for mounting in an electric-powered vehicle. This electricity storage device includes a plurality of electricity storage cells (unit cells) each comprising a secondary battery. The electricity storage cell includes a battery element enclosed in a primary packing container (outer package member) and is formed in a planar shape which is rectangular as seen in a plan view.

The battery element is formed by arranging a cathode plate and an anode plate opposite each other across a separator. Arranged between the cathode plate and the anode plate is an electrolytic solution injected into the primary packing container. Furthermore, an electrode terminal is connected to each of the cathode plate and the anode plate.

The primary packing container is formed of two laminates each composed of a metal foil and a thermal adhesive resin layer laid on each other. A housing portion for housing the battery element in it is provided in one of the laminates. With the battery element housed in the housing portion, peripheral parts of the two laminates are thermally bonded together using the thermal adhesive resin layer, and thus the battery element is sealed in the primary packing container.

In the electricity storage device, electricity storage cells in a rectangular shape as seen in a plan view are stacked on each other in their thickness direction, and such stacks of electricity storage cells are arranged side by side in their shorter-side direction and are covered with a secondary packing container (assembled battery cover).

Furthermore, a plurality of such electricity storage devices are stacked on each other in the thickness direction of the electricity storage cells and are mounted beneath the floor of the electric-powered vehicle.

### LIST OF CITATIONS

### Patent Literature

Patent Document 1: Japanese unexamined patent application publication No. 3719235 (pages 4-11, FIG. 7)

### SUMMARY OF INVENTION

### Technical Problem

Inconveniently, in the above-described known electricity storage device, the plurality of primary packing containers respectively sealing the electricity storage cells each have a metal foil. This leads to an increase in the cost of the primary packing container and the electricity storage device.

An object of the present invention is to provide an electricity storage device capable of achieving cost reduction and a method of manufacturing such an electricity storage device. Another object of the present invention is to provide an electric-powered vehicle using such an electricity storage device capable of achieving cost reduction.

### Solution to Problem

To achieve the above objects, according to one aspect of the present invention, in an electricity storage device, a plurality of planar electricity storage cells each having an electricity storage element sealed in a primary packing container are stacked on each other in tiers and sealed in a secondary packing container. The primary packing container is formed of a bag of resin formed by thermally bonding together peripheral parts of a resin sheet formed by laying on each other a barrier layer with a vapor-deposited coating and a thermal adhesive resin layer. The secondary packing container includes a first packing material and a second packing material each formed of a resin sheet formed by laying on each other a metal foil and a thermal adhesive resin layer, and peripheral parts of the first and second packing materials are thermally bonded together.

According to another aspect of the present invention, in an electricity storage device structured as described above, the electricity storage cell may be formed in a rectangular shape as seen in a plan view, and the primary packing container may be formed such that the distance between one pair of opposite sides and the distance between the other pair of opposite sides are each 500 mm or more.

According to another aspect of the present invention, in an electricity storage device structured as described above, the electricity storage cell may include a pair of electrode terminals which projects from the primary packing container, and the electrode terminals of the electricity storage cell may have a width of 50 mm or more in the circumferential direction.

According to another aspect of the present invention, in an electricity storage device structured as described above, the electrode terminals may have a thickness of 0.2 mm or more.

According to another aspect of the present invention, in an electricity storage device structured as described above, the first packing material may be formed of a molding of a sheet with a housing portion for housing the electricity storage cell formed in it.

According to another aspect of the present invention, in an electricity storage device structured as described above, the second packing material may be formed of a molding of a sheet with the housing portion formed in it.

According to another aspect of the present invention, in an electricity storage device structured as described above, the metal foil in the first packing material and the metal foil in the second packing material may have different thicknesses.

According to another aspect of the present invention, in an electricity storage device structured as described above, the vapor-deposited coating may be formed of an oxide.

According to another aspect of the present invention, in an electricity storage device structured as described above, the metal foil may be formed of aluminum.

According to another aspect of the present invention, an electric-powered vehicle includes an electricity storage device structured as described above.

According to another aspect of the present invention, a method of manufacturing an electricity storage device includes: a primary packing step of sealing an electricity storage element in a primary packing container to form a planar electricity storage cell; and a secondary packing step of stacking a plurality of the electricity storage cells on each other in tiers and sealing them in a housing portion provided in a secondary packing container. The primary packing container is formed of a bag of resin made of a resin sheet formed by laying on each other a barrier layer with a vapor-deposited coating and a thermal adhesive resin layer, and peripheral parts of the primary packing container having the electricity storage element inserted in it are thermally bonded together in the primary packing step. The secondary packing container includes a first packing material and a second packing material each formed of a resin sheet formed by laying on each other a metal foil and a thermal adhesive resin, and peripheral parts of the first and second packing materials are thermally bonded together in the secondary packing step.

According to another aspect of the present invention, in a method configured as described above, the electricity storage cell is formed in a rectangular shape as seen in a plan view, and a distance between one pair of opposite sides and a distance between the other pair of opposite sides are each 500 mm or more.

According to another aspect of the present invention, in a method configured as described above, the first packing material is formed of a molding of a sheet with the housing portion formed in it.

According to another aspect of the present invention, in a method configured as described above, the second packing material is formed of a molding of a sheet having the housing portion formed in it.

According to another aspect of the present invention, in a method configured as described above, the metal foil in the first packing material and the metal foil in the second packing material have different thicknesses.

### Advantageous Effects of Invention

According to the present invention, in an electricity storage device, an electricity storage element is sealed in a primary packing container formed of a bag of resin having a barrier layer with a vapor-deposited coating, and a plurality of such electricity storage cells are stacked on each other and sealed in a secondary packing container. The secondary packing container includes a first packing material and a second packing material with a metal foil, and peripheral parts of the first and second packing materials are thermally bonded together.

With this structure, the primary packing container has a barrier layer with a vapor-deposited coating and the secondary packing container has a metal foil, and thus it is possible to improve the gas barrier properties with respect to the electricity storage cells and the rigidity of the electricity storage device. This eliminates the need for a metal foil used in the primary packing container and helps reduce the cost of the primary packing container and the electricity storage device.

### BRIEF DESCRIPTION OF DRAWINGS

FIG. 1 is a side view of an electric-powered vehicle mounted with an electricity storage device according to a first embodiment of the present invention;

FIG. 2 is a top view of the electric-powered vehicle mounted with the electricity storage device according to the first embodiment of the present invention;

FIG. 3 is a cross-sectional front view of the electricity storage device according to the first embodiment of the present invention;

FIG. 4 is a top view of the electricity storage device according to the first embodiment of the present invention;

FIG. 5 is a cross-sectional side view of a resin sheet used to form a secondary packing container in the electricity storage device according to the first embodiment of the present invention;

FIG. 6 is a top view of an electricity storage cell in the electricity storage device according to the first embodiment of the present invention;

FIG. 7 is an exploded perspective view of a resin sheet used to form a primary packing container in the electricity storage device according to the first embodiment of the present invention;

FIG. 8 a cross-sectional front view of an electricity storage device according to a second embodiment of the present invention;

FIG. 9 is a top view of an electricity storage cell in the electricity storage device according to the second embodiment of the present invention;

FIG. 10 is a top view of an electricity storage cell in an electricity storage device according to a third embodiment of the present invention; and

FIG. 11 is a cross-sectional side view of the electricity storage cell in the electricity storage device according to the third embodiment of the present invention.

### DESCRIPTION OF EMBODIMENTS

### First Embodiment

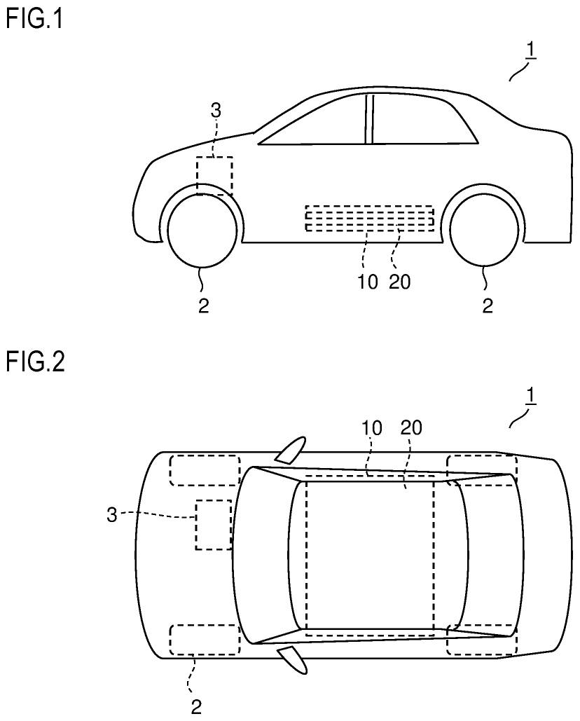

Embodiments of the present invention will be described below with reference to the accompanying drawings. FIGS. 1 and 2 are a side view and a top view, respectively, of an electric-powered vehicle 1 according to a first embodiment. The electric-powered vehicle 1 includes a driving motor 3 as a driving power source for driving wheels 2. Beneath the floor of the chassis of the electric-powered vehicle 1, an electricity storage device 10 is mounted as a driving source for supplying the driving motor 3 with electric power. The electricity storage device 10 may be mounted on the roof or in the seat of the electric-powered vehicle 1.

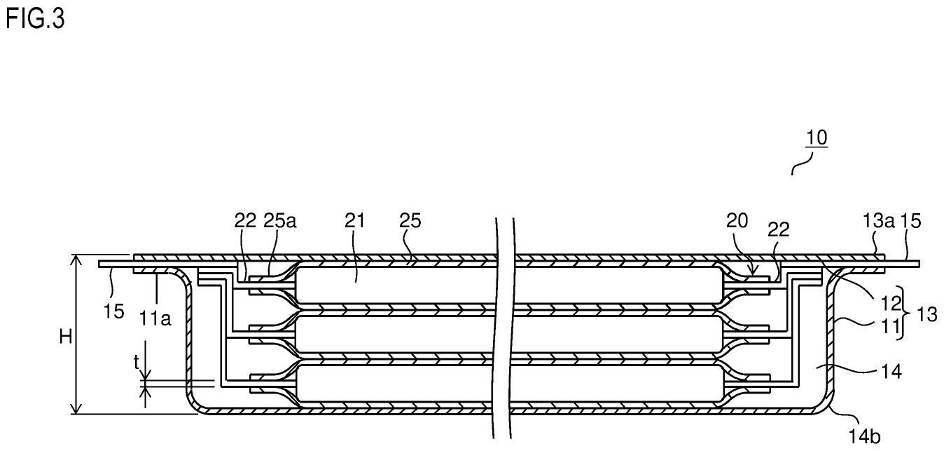

In a case where the electric-powered vehicle 1 is of a sedan type or a compact car type, the electricity storage device 10 is formed with a height H (see FIG. 3) of, for example, 100 mm or less. In a case where the electric-powered vehicle 1 is of an SUV type or a one-box type, the electricity storage device 10 is with a height H of, for example, 150 mm or less.

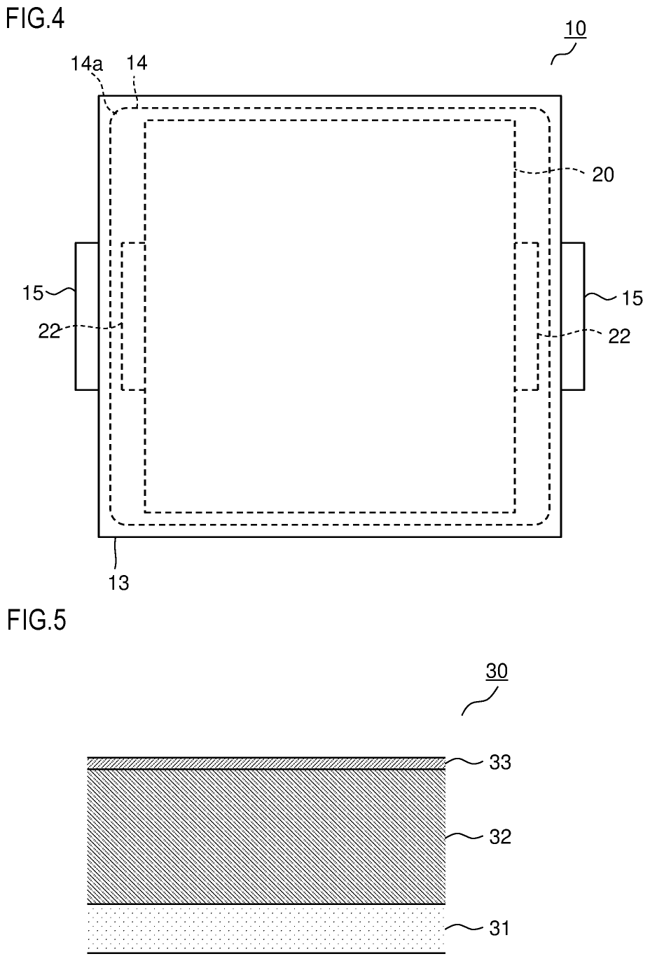

FIGS. 3 and 4 are a cross-sectional front view and a top view, respectively, of the electricity storage device 10. The electricity storage device 10 includes a plurality of planar electricity storage cells 20 which are stacked in the up-down direction. The electricity storage cells 20 are sealed in a primary packing container 25, and the electricity storage device 10 is sealed in a secondary packing container 13.

The secondary packing container 13 includes a first packing material 11 and a second packing material 12. The first packing material 11 is formed of a molding of a sheet formed by molding a laminated resin sheet 30 (see FIG. 5). The first packing material 11 has a housing portion 14, for accommodating the electricity storage cell 20, formed as a recess inside an annular flange portion 11a.

The housing portion 14 in the first packing material 11 is formed with a depth of, for example, about 100 mm. Here, each corner 14a of the housing portion 14 on a plane perpendicular to its depth direction has a radius of, for example, about 3 mm, and each corner 14b of the housing portion 14 on a plane parallel to its depth direction has a radius of, for example, about 1.5 mm.

A second packing material 12 is formed of a resin sheet 30 (see FIG. 5) similar to the first packing material 11 and is thermally bonded to the flange portion 11a. In this way, the secondary packing container 13 is sealed at a seal portion 13a that is formed by thermally bonding together peripheral parts of the first and second packing materials 11 and 12. Here, a pair of metal connecting terminals 15 is held between the flange portion 11a and the second packing material 12 so as to project from the peripheral edge of the secondary packing container 13. In this embodiment, the pair of connecting terminals 15 projects from opposite sides of the secondary packing container 13, which is in a rectangular shape as seen in a plan view.

FIG. 5 is a sectional view showing the layered structure of the resin sheet 30 which forms the first and second packing materials 11 and 12. The resin sheet 30 is formed by laying on each other, in order from the inner side, a thermal adhesive resin layer 31, a barrier layer 32, and a protection layer 33.

The thermal adhesive resin layer 31 is formed of a thermal adhesive resin with a thickness of, for example, 10 μm or more but 100 μm or less. The thermal adhesive resin layer 31 may be formed by extrusion over the barrier layer 32 or dry-laminated on the barrier layer 32.

Usable as the thermal adhesive resin layer 31 is, for example, low-density polyethylene, straight-chain low-density polyethylene, polypropylene, or acid-modified polypropylene. Acid-modified polypropylene, having high adhesive strength with respect to the metal connecting terminals 15, is more preferable. In this embodiment, used as the thermal adhesive resin layer 31 is acid-modified polypropylene with a thickness of 80 μm.

In a case where, as the thermal adhesive resin layer 31, use is made of low-density polyethylene, straight-chain low-density polyethylene, polypropylene, or the like having low adhesive strength with respect to the connecting terminals 15, it is preferable to provide a film adhesive to metal terminals between the connecting terminal 15 and the thermal adhesive resin layer 31. Usable as the film adhesive to metal terminals is, for example, a single-layer film of acid-modified polypropylene or a multilayer film having acid-modified polypropylene at least on one side.

The barrier layer 32 is formed of a metal foil such as of aluminum (including an alloy of aluminum), stainless steel, or titanium. The barrier layer 32 prevents entry of moisture, oxygen, light, and the like. The barrier layer 32 in the first and second packing materials 11 and 12 is formed with a thickness of, for example, from 300 μm to 1000 μm. In this way, it is possible to improve the rigidity of the secondary packing container 13 and the electricity storage device 10. This helps prevent faults due to deformation of the electricity storage device 10 mounted in the electric-powered vehicle 1.

The secondary packing container 13 packages a plurality of electricity storage cells 20, each sealed in the primary packing container 25, in a state where they are stacked in the up-down direction, to form the electricity storage device 10. A plurality of electricity storage devices 10 are, or a single electricity storage device 10 is, provided as a driving power source, for example, beneath the floor or in the seat of the electric-powered vehicle 1. Thus, the secondary packing container 13 needs to be formed of a material with high rigidity, and thus one or both of the first and second packing materials 11 and 12 are formed of a laminate with high rigidity.

Thus, for the barrier layer 32 in one or both of the first and second packing materials 11 and 12, a metal with high rigidity is used. Examples of metals with high rigidity include foils of aluminum alloys such as JIS A3003 and JIS A3004 and stainless steel such as SUS304, SUS301, and SUS316L. By forming the barrier layer 32 out of such a metal with a thickness of 300 μm to 1000 μm, it is possible to improve the rigidity of the secondary packing container 13 while reducing the cost of the secondary packing container 13.

In a case where one of the first and second packing materials 11 and 12 is formed of a laminate with high rigidity, a metal with high ductility and malleability with a thickness of from 10 to 100 μm may be used as the other barrier layer 32.

In this embodiment, the barrier layer 32 in the first packing material 11 is formed of an aluminum foil with a thickness of 500 μm so as to correspond to the housing portion 14 with a depth of about 100 mm. On the other hand, the barrier layer 32 in the second packing material 12 is formed of an aluminum foil with a thickness of 40 μm.

It is possible to form the barrier layer 32 in the first packing material 11 and the barrier layer 32 in the second packing material 12 both out of an aluminum foil with a thickness of 500 μm. Instead, it is also possible to form the barrier layer 32 in the first packing material 11 out of an aluminum foil with a thickness of 40 μm and the barrier layer 32 in the second packing material 12 out of an aluminum foil with a thickness of 500 μm.

The protection layer 33 is electrically insulating and is formed of a resin film such as of nylon, polyester, or polyethylene terephthalate. The protection layer 33 is dry-laminated on the barrier layer 32. The protection layer 33 is formed with a thickness of, for example, 10 μm or more but 75 μm or less.

For enhanced pinhole resistance, enhanced electrical insulation, and the like, the protection layer 33 may be formed by laying on each other a plurality of resin films of different materials. In this embodiment, the protection layer 33 in the first packing material 11 is formed of polyethylene terephthalate with a thickness of 12 μm. The protection layer 33 in the second packing material 12 is formed by dry-laminating polyethylene terephthalate with a thickness of 12 μm and nylon with a thickness of 15 μm.

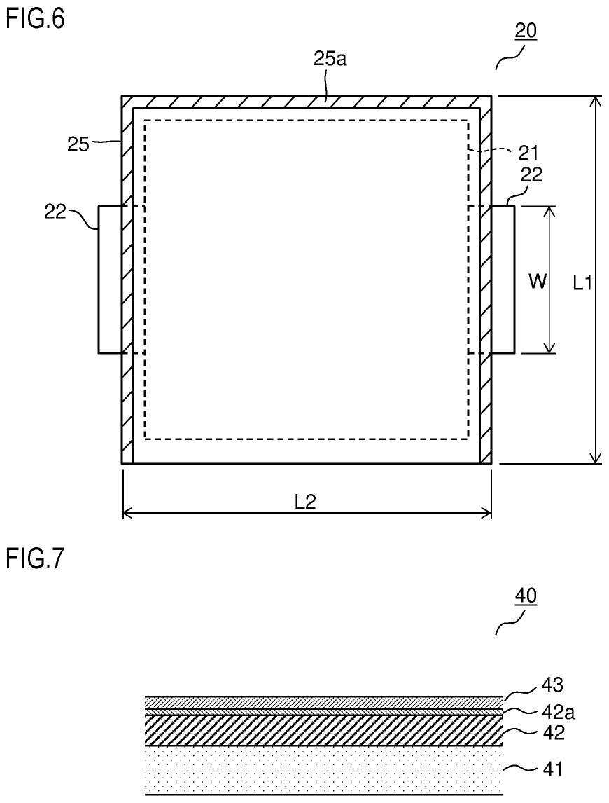

FIG. 6 is a top view of the electricity storage cell 20. In FIGS. 3 and 6, the electricity storage cell 20 comprises a secondary battery having an electricity storage element 21 sealed in the primary packing container 25. Usable as the electricity storage cell 20 is, for example, a lithium-ion battery, a lithium-ion polymer battery, an all solid lithium-ion battery, a lead storage battery, a nickel-hydride storage battery, a nickel-cadmium storage battery, a nickel-iron storage battery, a nickel-zinc storage battery, a silver oxide-zinc storage battery, a metal-air battery, or a polyvalent cation battery.

The electricity storage element 21 is formed by arranging a cathode plate and an anode plate (neither is shown) opposite each other across an electrically insulating separator (not shown). The electricity storage element 21 can be formed by winding up a separator, a cathode plate, and an anode plate, all in an elongate form. The electricity storage element 21 may instead be formed by laying on each other a cathode plate, a separator, an anode plate, and a separator, all in a sheet form, in this order in a plurality of tiers. The electricity storage element 21 may instead be formed by folding up and thereby laying on each other a separator, a cathode plate, and an anode plate, all in an elongate form.

Between the cathode plate and the anode plate, an electrolyte is arranged. In this embodiment, the electrolyte is an electrolytic solution, and fills the inside of the primary packing container 25. As the electrolyte, a solid electrolyte or a gel electrolyte may be used.

To the cathode and anode plates, electrode terminals 22 made of metal are connected respectively. The pair of electrode terminals 22 projects from opposite sides of the primary packing container 25. Arranging the electrode terminals 22 close to each other invites a sharp rise in temperature near the electrode terminals 22, and makes the electricity storage cell 20 more prone to aging degradation. Thus, arranging the pair of electrode terminals 22 at opposite sides of the primary packing container 25 helps suppress aging degradation of the electricity storage cell 20.

The pair of electrode terminals 22 may be arranged at the same side of the primary packing container 25 away from each other, or may be arranged on adjacent sides. However, arranging the pair of electrode terminals 22 at opposite sides of the primary packing container 25 as in this embodiment is more effective in suppressing aging degradation of the electricity storage cell 20 and is thus more preferable.

The electrode terminal 22 is formed with a thickness t of 0.2 mm or more and with a width W of 50 mm or more in the circumferential direction. This helps reduce power loss in the electricity storage cell 20 due to the electrical resistance of the electrode terminal 22.

The electrode terminals 22 of a plurality of electricity storage cells 20 are bundled together, cathodes and anodes separately, to be connected to the connecting terminals 15 respectively by welding or the like.

The primary packing container 25 is formed of a bag of resin, and is formed as a three side-closed bag formed by folding up a resin sheet 40 (see FIG. 7) as will be described later and thermally bonding together peripheral parts of it as the seal portion 25a. Thus, the electricity storage cell 20 is formed in a rectangular shape as seen in a plan view. The primary packing container 25 is formed such that the distance L1 between one pair of opposite sides and the distance L2 between the other pair of opposite sides are each 500 mm or more.

Thus, it is possible to increase the capacity of the electricity storage cell 20 while reducing the number of components of the electricity storage device 10 of the desired capacity. In addition, it is also possible to reduce the number of electricity storage devices 10 mounted in the electric-powered vehicle 1. Thus, it is possible to reduce the cost of the electricity storage device 10 and the electric-powered vehicle 1.

FIG. 7 is a sectional view showing the layered structure of the resin sheet 40 which forms the primary packing container 25. The resin sheet 40 is formed by laying on each other, in order from the inner side, a thermal adhesive resin layer 41, a barrier layer 42, and a protection layer 43.

The thermal adhesive resin layer 41 is formed of a thermal adhesive resin with a thickness of, for example, 10 μm or more but 100 μm or less. Usable as the thermal adhesive resin layer 41 is, for example, low-density polyethylene, straight-chain low-density polyethylene, polypropylene, or acid-modified polypropylene. Acid-modified polypropylene, having high adhesive strength with respect to the metal electrode terminals 22, is more preferable. In this embodiment, used as the thermal adhesive resin layer 41 is acid-modified polypropylene with a thickness of 80 μm.

In a case where, as the thermal adhesive resin layer 41, use is made of low-density polyethylene, straight-chain low-density polyethylene, polypropylene, or the like having low adhesive strength with respect to the electrode terminals 22, it is preferable to provide a film adhesive to metal terminals between the electrode terminal 22 and the thermal adhesive resin layer 31. Usable as the film adhesive to metal terminals is, for example, a single-layer film of acid-modified polypropylene or a multilayer film having acid-modified polypropylene at least on one side.

The barrier layer 42 is formed of a vapor-deposited film having a vapor-deposited coating 42a and is dry-laminated on the thermal adhesive resin layer 41. The barrier layer 42 is formed with a thickness of, for example, 10 μm or more but 75 μm or less.

The vapor-deposited coating 42a prevents entry of moisture, oxygen, and the like. The barrier layer 32 formed of a metal foil in the secondary packing container 13 has higher barrier properties than the barrier layer 42. Usable as the vapor-deposited coating 42a is, for example, aluminum, silicon dioxide, or alumina. A vapor-deposited coating 42a formed of an oxide such as silicon dioxide or alumina gives the primary packing container 25 higher electrical insulation than a metal vapor-deposited coating. It is thus possible to enhance the reliability of the electricity storage device 10. In this embodiment, the vapor-deposited coating 42a is formed of silicon dioxide.

The protection layer 43 is electrically insulating and is formed of a resin film such as of nylon, polyester, or polyethylene terephthalate. The protection layer 43 is formed with a thickness of, for example, 10 μm or more but 75 μm or less. For enhanced heat resistance, the protection layer 43 is preferably formed of a uniaxially stretched film or a biaxially stretched film.

For enhanced pinhole resistance, enhanced electrical insulation, and the like, the protection layer 43 may be formed by laying on each other a plurality of resin films of different materials. In that case, the plurality of resin films are bonded together with polyurethane-based, acrylic, or other adhesive. In this embodiment, the protection layer 43 is formed by dry-laminating polyethylene terephthalate (with a thickness of 12 μm) and nylon (with a thickness of 15 μm).

The electricity storage device 10 is formed through a primary packing step and a secondary packing step. In the primary packing step, the electrode terminals 22 of the electricity storage element 21 are arranged so as to project from opposite end parts of the resin sheet 40 folded in two. Next, the opposite end parts, which cross over the electrode terminals 22, are thermally bonded together as the seal portion 25a to form the primary packing container 25 in the shape of a bag having an opening at one end. Then, the primary packing container 25 is filled with an electrolytic solution, and the opening is thermally bonded at the seal portion 25a. In this way, the planar electricity storage cell 20 with the electricity storage element 21 sealed in the primary packing container 25 is formed.

In the secondary packing step, a plurality of electricity storage cells 20 are stacked on each other in tiers and are housed in the housing portion 14 in the secondary packing container 13, and the electrode terminals 22 are connected together in a predetermined order and are connected to the connecting terminals 15. Next, with the connecting terminals 15 arranged on the flange portion 11a of the first packing material 11, the seal portion 13a is formed by thermally bonding together peripheral parts of the first and second packing materials 11 and 12. In this way, the electricity storage device 10 is sealed.

In the electricity storage device 10 structured as described above, the barrier layer 32 formed of a metal foil in the secondary packing container 13 prevents entry of moisture and oxygen into the electricity storage cell 20 housed in the secondary packing container 13. Here, a tiny amount of moisture and the like may enter the electricity storage device 10 through the end face of the seal portion 13a of the secondary packing container 13 via the thermal adhesive resin layer 31. However, even if a tiny amount of moisture and the like enters the electricity storage device 10, the vapor-deposited coating 42a on the primary packing container 25 can reliably prevent entry of moisture and the like into the electricity storage cell 20.

In addition, the barrier layer 42 in the primary packing container 25 prevents leakage of the electrolytic solution by volatilization. Here, even if a tiny amount of volatilized electrolytic solution passes through the barrier layer 42, the barrier layer 32 formed of a metal foil in the secondary packing container 13 can reliably prevent leakage of the electrolytic solution. Thus, it is possible to enhance the gas barrier properties with respect to the electricity storage cell 20, and this helps suppress deterioration of the electricity storage cell 20 due to moisture and the like or due to leakage of the electrolytic solution.

According to this embodiment, the electricity storage device 10 has a plurality of electricity storage cells 20 stacked on each other and sealed in the secondary packing container 13. The electricity storage cell 20 has the electricity storage element 21 sealed in the primary packing container 25, which is a bag of resin having the barrier layer 42 with the vapor-deposited coating 42a. The secondary packing container 13 includes the first and second packing materials 11 and 12 formed of the resin sheet 30 having a metal foil, and peripheral parts of the first and second packing materials are thermally bonded together.

In this way, it is possible to improve the gas barrier properties with respect to the electricity storage cell 20 and the rigidity of the electricity storage device 10. Thus, it is possible to eliminate the need for a metal foil in the primary packing container 25, and this helps reduce the cost of the primary packing container 25 and the electricity storage device 10. Also, with the first and second packing materials 11 and 12 formed of the resin sheet 30, it is possible to easily produce a secondary packing container 13 with high barrier properties and high rigidity.

The electricity storage cell 20 is in a rectangular shape as seen in a plan view, and the primary packing container 25 is formed such that the distance L1 between one pair of opposite sides and the distance L2 between the other pair of opposite sides are each 500 mm or more. Thus, it is possible to increase the capacity of the electricity storage cell 20 while reducing the number of components of the electricity storage device 10 of the desired capacity and thereby to reduce the cost of the electricity storage device 10 and the electric-powered vehicle 1.

The electrode terminals 22 of the electricity storage cell 20 have a width W of 50 mm or more in the circumferential direction, and thus it is possible to reduce power loss in the electricity storage cell 20 due to the electrical resistance of the electrode terminal 22.

The electrode terminal 22 is formed with a thickness t of 0.2 mm or more, and thus it is possible to reduce power loss in the electricity storage cell 20 due to the electrical resistance of the electrode terminal 22.

The vapor-deposited coating 42a on the barrier layer 42 in the primary packing container 25 is formed of silicon dioxide, which is an oxide, and this gives the primary packing container 25 high electrical insulation. It is thus possible to enhance the reliability of the electricity storage device 10.

The metal foil that forms the barrier layer 32 in the secondary packing container 13 is formed of aluminum, and thus it is possible to easily produce a secondary packing container 13 with high barrier properties and high rigidity.

The first packing material 11 is formed of a molding of a sheet with the housing portion 14 for housing the electricity storage cell 20 formed in it, and thus it is possible to easily produce a secondary packing container 13 having the housing portion 14.

### Second Embodiment

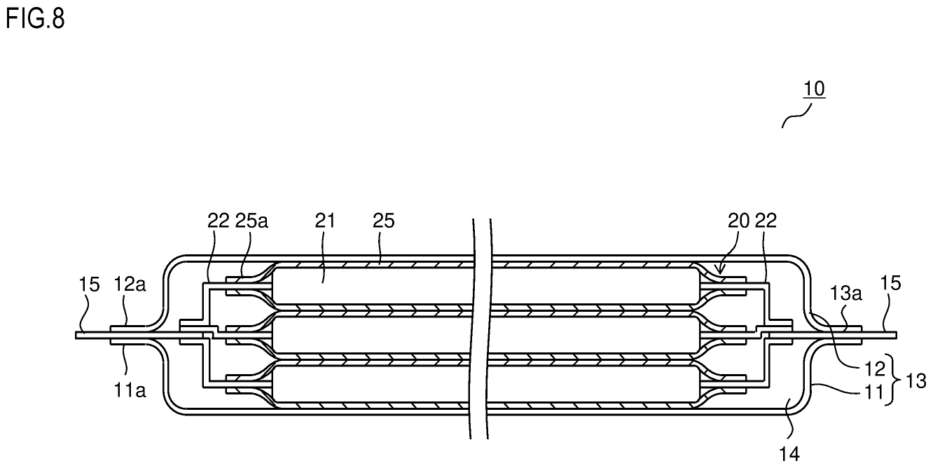

FIG. 8 is a sectional front view of an electricity storage device 10 according to a second embodiment. For the sake of convenience, such parts as find their counterparts in the first embodiment shown in FIGS. 1 to 8 referred to previously are identified by the same reference signs. This embodiment differs from the first embodiment in the shapes of the primary packing container 25 and the secondary packing container 13, and is in other respects similar to the first embodiment.

The first and second packing materials 11 and 12 of the secondary packing container 13 are formed in similar shapes out of a molding of a sheet formed by molding a laminated resin sheet 30 (see FIG. 5). The first and second packing materials 11 and 12 each have a housing portion 14, for accommodating the electricity storage cell 20, formed as a recess inside an annular flange portion 11a or 11b respectively. In this embodiment, the barrier layer 32 in the first and second packing materials 11 and 12 is formed of an aluminum foil with a thickness of 500 μm. The housing portion 14 in the first and second packing materials 11 and 12 is formed with a depth of about 50 mm.

The thermal adhesive resin layer 31 in the flange portions 11a and 12a is thermally bonded together to form an annular seal portion 13a along the circumference of the housing portion 14. Thus, the housing portion 14 formed with a predetermined depth from the inner edge of the seal portion 13a is sealed at the seal portion 13a.

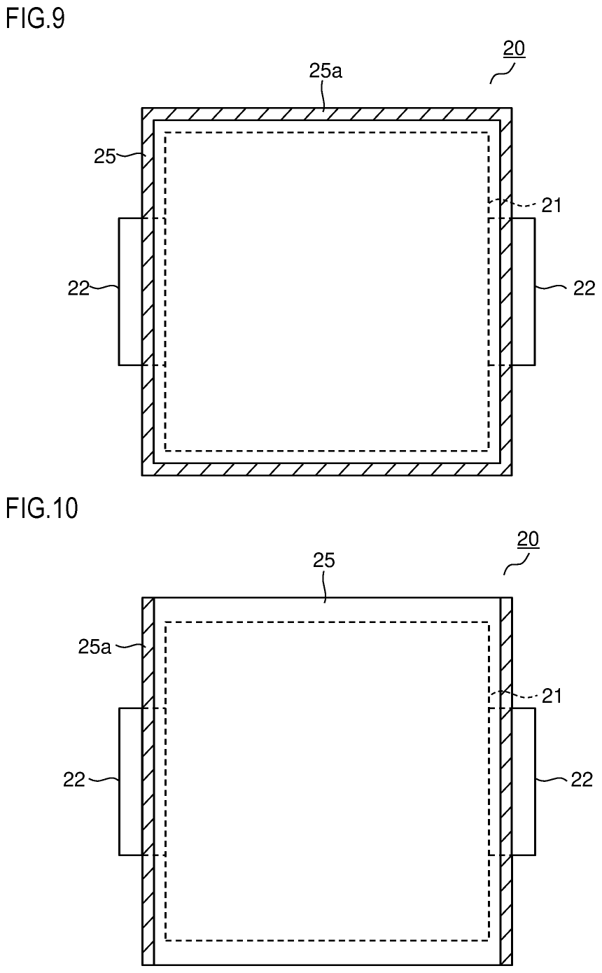

FIG. 9 is a top view of the electricity storage cell 20. The primary packing container 25 of the electricity storage cell 20 is formed of a bag of resin, and is formed as a four side-closed bag having two resin sheets 40 (see FIG. 7) laid over each other and thermally bonded together in a peripheral part as a seal portion 25a. Thus, the electricity storage cell 20 is formed in a rectangular shape as seen in a plan view.

In this embodiment, as in the first embodiment, the secondary packing container 13 has the barrier layer 32 formed of a metal foil, and the barrier layer 42 in the primary packing container 25 has the vapor-deposited coating 42a. This helps improve the gas barrier properties with respect to the electricity storage cell 20 and the rigidity of the electricity storage device 10. It is thus possible to reduce the cost of the primary packing container 25 and the electricity storage device 10. It is also possible to easily produce a secondary packing container 13 with high gas barrier properties and high rigidity owing to the first and second packing materials 11 and 12 formed of the resin sheet 30.

Moreover, since the first and second packing materials 11 and 12 are formed of a molding of a sheet with the housing portion 14 formed in it, it is possible to reduce the depth of the housing portion 14 in each of the first and second packing materials 11 and 12. This helps reduce cracks and the like during sheet molding. By forming the housing portion 14 in each of the first and second packing materials 11 and 12 with a depth similar to that of the first packing material 11 in the first embodiment, it is possible to produce an electricity storage device 10 with a still higher capacity.

In this embodiment, the primary packing container 25 may be formed as a three side-closed bag as in the first embodiment.

### Third Embodiment

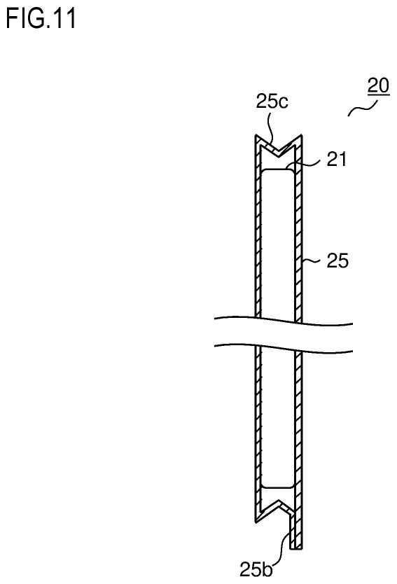

FIGS. 10 and 11 are a top view and a sectional side view, respectively, of an electricity storage cell 20 in an electricity storage device 10 according to a third embodiment. For the sake of convenience, such parts as find their counterparts in the first embodiment shown in FIGS. 1 to 8 referred to previously are identified by the same reference signs. This embodiment differs from the first embodiment in the shape of the primary packing container 25, and is in other respects similar to the first embodiment.

The primary packing container 25 is formed of a bag of resin made of the resin sheet 40 (see FIG. 7), and is formed as a gusseted bag with a gusset portion 25c. The primary packing container 25 has the resin sheet 40 folded up to turn around while forming the gusset portion 25c, and has opposite end parts of the resin sheet 40 in its shorter-side direction thermally bonded together as a seal portion 25a, with electrode terminals 22 held in between. Opposite end parts of the turned-around resin sheet 40 in its longer-side direction are thermally bonded together as a seal portion 25b. Thus, the electricity storage cell 20 is formed in a rectangular shape as seen in a plan view.

In this embodiment, as in the first embodiment, the secondary packing container 13 has the barrier layer 32 formed of a metal foil, and the barrier layer 42 in the primary packing container 25 has the vapor-deposited coating 42a. This helps improve the gas barrier properties against the electricity storage cell 20 and the rigidity of the electricity storage device 10. It is thus possible to reduce the cost of the primary packing container 25 and the electricity storage device 10. It is also possible to easily produce a secondary packing container 13 with high gas barrier properties and high rigidity owing to the first and second packing materials 11 and 12 formed of a resin sheet.

Moreover, since the primary packing container 25 is formed of a bag of resin having the gusset portion 25c, it is possible to make the primary packing container 25 less prone to breakage as a result of sliding between the inner surface of the primary packing container 25 and the electricity storage element 21.

In this embodiment, the secondary packing container 13 may be formed similarly as in the second embodiment.

While in the first to third embodiments the electricity storage cell 20 that supplies the driving motor 3 with electric power is a secondary battery, it may instead be a capacitor (electrolytic capacitor, electrical double layer capacitor, lithium-ion capacitor, or the like).

### INDUSTRIAL APPLICABILITY

The present invention finds wide application in electric-powered vehicles furnished with electricity storage devices.

### REFERENCE SIGNS LIST

1 electric-powered vehicle
2 wheel
3 driving motor
10 electricity storage device
11 first packing material
11a, 12a flange portion
12 second packing material
13 secondary packing container
13a seal portion
14 housing portion
15 connecting terminal
20 electricity storage cell
21 electricity storage element
22 electrode terminal
25 primary packing material
25a, 25b seal portion
25c gusset portion
30, 40 resin sheet
31, 41 thermal adhesive resin layer
32, 42 barrier layer
33, 43 protection layer
42a deposited coating

1-15. (canceled)

16. An electricity storage device in which a plurality of planar electricity storage cells each having an electricity storage element sealed in a primary packing container are stacked on each other in tiers and sealed in a secondary packing container,
wherein
the primary packing container is formed of a bag of resin formed by thermally bonding together peripheral parts of a resin sheet formed by laying on each other a barrier layer with a vapor-deposited coating and a thermal adhesive resin layer, and
the secondary packing container includes a first packing material and a second packing material each formed of a resin sheet formed by laying on each other a metal foil and a thermal adhesive resin layer, and peripheral parts of the first and second packing materials are thermally bonded together.

17. The electricity storage device according to claim 16,
wherein
the electricity storage cell is formed in a rectangular shape as seen in a plan view, and
the primary packing container is formed such that a distance between one pair of opposite sides and a distance between another pair of opposite sides are each 500 mm or more.

18. The electricity storage device according to claim 17,
wherein
the electricity storage cell includes a pair of electrode terminals which projects from the primary packing container, and
the electrode terminals of the electricity storage cell have a width of 50 mm or more in a circumferential direction.

19. The electricity storage device according to claim 18,
Wherein
the electrode terminals have a thickness of 0.2 mm or more.

20. The electricity storage device according to claim 16,
wherein
the first packing material is formed of a molding of a sheet with a housing portion for housing the electricity storage cell formed therein.

21. The electricity storage device according to claim 20,
wherein
the second packing material is formed of a molding of a sheet with the housing portion formed therein.

22. The electricity storage device according to claim 16,
wherein
the metal foil in the first packing material and the metal foil in the second packing material have different thicknesses.

23. The electricity storage device according to claim 16,
wherein
the vapor-deposited coating is formed of an oxide.

24. The electricity storage device according to claim 16,
wherein
the metal foil is formed of aluminum.

25. The electricity storage device according to claim 16,
wherein
the housing portion for housing the electricity storage cell is formed as a recess in the first packing material and is not formed in the second packing material, and
the metal foil in the second packing material has a thickness greater than a thickness of the metal foil in the first packing material.

26. The electricity storage device according to claim 16,
wherein
the housing portion for housing the electricity storage cell is formed as a recess in the first packing material and is not formed in the second packing material, and
the metal foil in the first packing material has a thickness greater than a thickness of the metal foil in the second packing material.

27. The electricity storage device according to claim 16,
wherein
the secondary packing container has, on an outer side of the barrier layer, a protection layer formed by dry-laminating polyethylene terephthalate and nylon.

28. An electric-powered vehicle comprising the electricity storage device according to claim 16.

29. A method of manufacturing an electricity storage device, the method comprising:
a primary packing step of sealing an electricity storage element in a primary packing container to form a planar electricity storage cell; and
a secondary packing step of stacking a plurality of the electricity storage cells on each other in tiers and sealing them in a housing portion provided in a secondary packing container and are sealed therein,
wherein
the primary packing container is formed of a bag of resin made of a resin sheet formed by laying on each other a barrier layer with a vapor-deposited coating and a thermal adhesive resin layer, and peripheral parts of the primary packing container having the electricity storage element inserted therein are thermally bonded together in the primary packing step, and
the secondary packing container includes a first packing material and a second packing material each formed of a resin sheet formed by laying on each other a metal foil and a thermal adhesive resin, and peripheral parts of the first and second packing materials are thermally bonded together in the secondary packing step.

30. The method according to claim 29,
wherein
the housing portion for housing the electricity storage cell is formed as a recess in the first packing material and is not formed in the second packing material, and
the metal foil in the second packing material has a thickness greater than a thickness of the metal foil in the first packing material.

31. The method according to claim 29,
wherein
the housing portion for housing the electricity storage cell is formed as a recess in the first packing material and is not formed in the second packing material, and
the metal foil in the first packing material has a thickness greater than a thickness of the metal foil in the second packing material.

32. The method according to claim 29,
wherein
the secondary packing container has, on an outer side of the barrier layer, a protection layer formed by dry-laminating polyethylene terephthalate and nylon.
